(19) United States
(12) Patent Application Publication
(10) Pub. No.: US 2010/0151834 A1
(43) Pub. Date: Jun. 17, 2010

(54) METHODS AND SYSTEMS FOR OPTIMIZING A VISUAL VOICE MAIL SYSTEM BY REDUCING THE USE OF COMMUNICATION RESOURCES

(75) Inventor: Rohit Satish KALBAG, Bridgewater, NJ (US)

Correspondence Address: VERIZON;PATENT MANAGEMENT GROUP, 1320 North Court House Road, 9th Floor, ARLINGTON, VA, 22201-2909, US

(73) Assignee: VERIZON CORPORATE GROUP SERVICES INC., Basking Ridge, NJ (US)

(21) Appl. No.: 12/334,835

(22) Filed: Dec. 15, 2008

(51) Int. Cl. H04M 3/42

(52) U.S. Cl. 455/413; 455/412.2

(57) ABSTRACT

A system and method in accordance with exemplary embodiments may receive, from a server, one or more notification messages indicating an occurrence of one or more voice mail events via a network. The system and method may then transmit, to the server, one or more session initiation messages in response to the receipt of the one or more notification messages via the network. Further, the system and method may retrieve, from the server, voice mail data associated with the one or more voice mail events via a communication session.

### BACKGROUND INFORMATION

In many instances, visual voice mail technology configured to operate on mobile devices (e.g., cellular phones, smart phones) may maintain long-lived communication sessions between the mobile devices and the voice mail server to ensure that the voice mail boxes on the mobile devices remain synchronized with the voice mail server. These long-lived communication sessions, however, may utilize expensive radio resources to maintain connectivity. Given the current limits on radio and communication resources, mobile telephone service providers may desire more efficient ways to provide visual voice mail services to their customers. In addition, these mobile telephone service providers may begin to use Voice over Internet Protocol (VoIP) technologies and may desire to leverage the communication resources of VoIP for other services, such as visual voice mail.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1A illustrates a block diagram of a visual voice mail system in accordance with exemplary embodiments;

FIG. 1B illustrates a block diagram of an exemplary implementation of a visual voice mail system in accordance with exemplary embodiments;

FIG. 2 illustrates exemplary modules of a voice mail server of a visual voice mail system in accordance with exemplary embodiments;

FIG. 3 illustrates exemplary modules of a mobile device of a visual voice mail system in accordance with exemplary embodiments;

FIG. 4 illustrates an exemplary schematic of an implementation of a visual voice mail system that has been optimized by reducing the use of bandwidth resources in accordance with exemplary embodiments;

FIG. 5 illustrates a flowchart of a method for optimizing a visual voice mail system by reducing the use of bandwidth resources at a voice mail server in accordance with exemplary embodiments; and

FIG. 6 illustrates a flowchart of a method for optimizing a visual voice mail system by reducing the use of bandwidth resources at a mobile device in accordance with exemplary embodiments.

These and other embodiments and advantages will become apparent from the following detailed description, taken in conjunction with the accompanying drawings, illustrating by way of example the principles of the various exemplary embodiments.

### DETAILED DESCRIPTION OF PREFERRED EMBODIMENTS

The description below describes servers, mobile devices, and telephone devices that may include one or more modules, some of which are explicitly shown in the figures, others that are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

The description below also describes physical and logical elements of a system, some of which are explicitly shown in figures, others that are not. The inclusion of some physical elements of a system may help illustrate how a given system may be modeled. It should be noted, however, that all illustrations are purely exemplary and that the visual voice mail system described herein may be performed on different varieties of systems which may include different physical and logical elements.

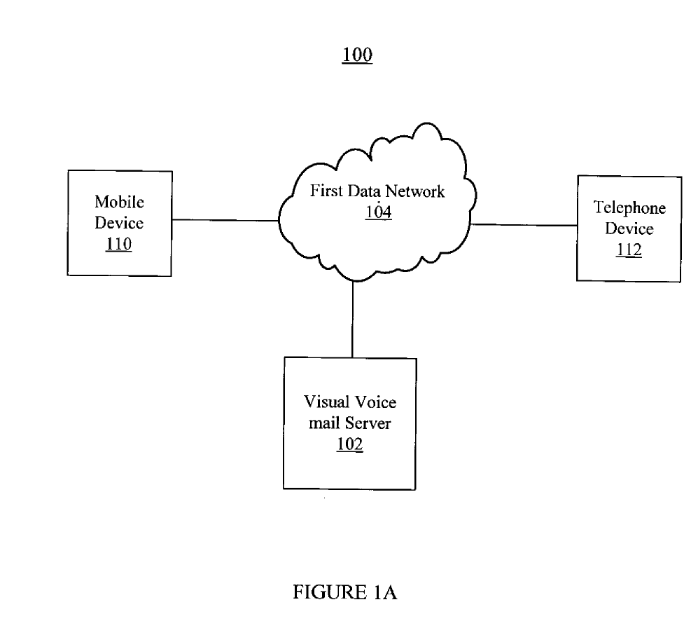

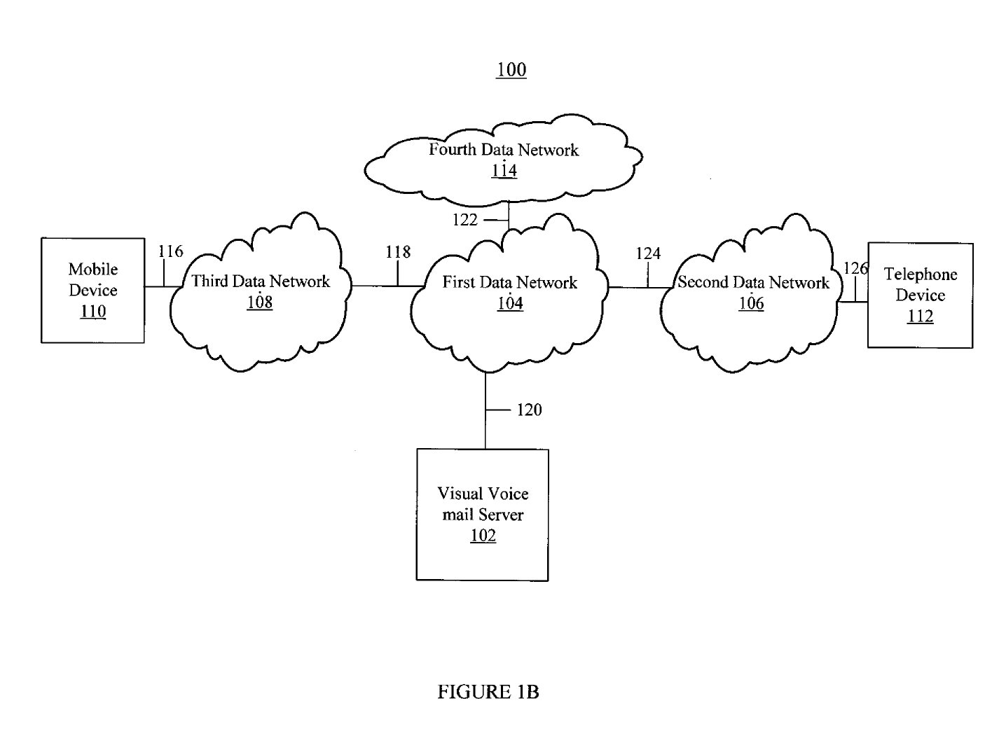

For instance, visual voice mail system 100 from FIG. 1 illustrates a simplified view of a system and various elements in the system. It is noted that other hardware and software not depicted may be included in the visual voice mail system 100. It is also noted that the visual voice mail system 100 illustrates a specific number of instances of a visual voice mail server 102, a mobile device 110, and a telephone device 106. It will be appreciated that a single instance and/or multiple instances of these entities may be included in a visual voice mail system 100.

It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, mobile devices, and telephone devices) separately. The functions described as being performed at various components may be performed at other components, and the various components may be combined and/or separated. Other modifications also may be made.

Traditionally, mobile devices configured with visual voice mail (VVM) capabilities may utilize existing email technologies (e.g., Internet Message Access Protocol (IMAP)) to retrieve VVM messages from a VVM server. These email technologies, however, may cause the mobile devices and/or VVM servers to maintain long-lived communication sessions to ensure that voice mail boxes of the mobile devices remain synchronized with the VVM servers. As a result of the increase in mobile devices operating with VVM capabilities and the limits on bandwidth resources, mobile devices configured with bandwidth efficient VVM capabilities may need to enter the market. To this end, a VVM system that implements bandwidth efficient VVM technologies is described herein.

In an exemplary embodiment, a VVM system may be configured to provide VVM data to a mobile device by establishing a communication session between the mobile device and a VVM server in response to the occurrence of one or more voice mail events. In various embodiments, VVM data may include data associated with one or more VVM messages and/or data associated with the modification of one or more voice mail settings. In various embodiments, a voice mail event may include the existence of one or more new VVM messages and/or a modification of one or more voice mail settings.

In an exemplary embodiment, VVM may include one or more VVM messages (e.g., VVM data) that may be outputted (e.g., displayed) to a user such that the user may manipulate and/or manage the VVM using the mobile device. VVM may enable the user to view a list of one or more VVM messages. In various embodiments, VVM messages may be displayed with information, such as: the date and/or time of receipt of the VVM message and the VVM message duration. Using this information, the user may prioritize and/or manage one or more VVM messages using the mobile device. In various embodiments, a display device associated with the mobile device may enable the user to return the call of the creator of a VVM message, reply back to a VVM message, forward a VVM message, add the creator of a VVM message to a contacts list, and/or archive a VVM message to memory (e.g., internal memory, external memory).

For example, in response to the occurrence of a first voice mail event that includes receiving a new VVM message associated with a first mobile device from a first telephone device at the VVM server, the VVM system may provide the VVM data associated with the new VVM message to the first mobile device by establishing a first communication session. In another example, in response to the occurrence of a second voice mail event that includes the modification of a Personal Identification Number (PIN) associated with the first mobile device at the VVM server, the VVM system may provide the VVM data associated with the modified PIN to the first mobile device by establishing a second communication session. In yet another example, in response to the occurrence of a third voice mail event that includes a status change of VVM messages that is due to the retrieval of a new VVM message at the VVM server, the VVM system may provide the VVM data associated with the status change to the first mobile device by establishing a third communication session.

In an exemplary embodiments, the VVM system may be configured to initiate the establishment of a communication session between the mobile device and the VVM server by transmitting one or more notification messages from the VVM server to the mobile device. In various embodiments, a notification message may include one or more Session Initiation Protocol (SIP) notification messages that indicate the occurrence of one or more voice mail events.

It should be noted that one or more VVM servers associated with the VVM system may operate according to one or more internet email protocols (e.g., IMAP). Accordingly, one or more VVM servers of the VVM system may be configured to operate as an IMAP server. It should also be noted that one or more mobile devices associated with the VVM system may operate according to one or more internet email protocols (e.g., IMAP). Accordingly, one or more mobile devices of the VVM system may be configured to operate as an IMAP client.

FIG. 1A illustrates a block diagram of a VVM system 100 in accordance with exemplary embodiments. In an exemplary embodiment, the VVM system 100 may include one or more VVM servers 102, one or more first data networks, one or more mobile devices 110, and/or one or more telephone devices 112. It is noted that the devices/networks 102, 104, 110, and 112 are exemplary. The functions of the devices/networks 102, 104, 110, and 112 may be performed at other devices/networks remote or local to the VVM system 100, and the devices/networks 102, 104, 110, and 112 may be combined and/or separated.

The VVM system 100 may be in communication with the first data network 104. The first data network 104 may include one or more of a local area networks (LANs), one or more wide area networks (WANs), one or more radio access networks (RANs), the Internet, one or more cellular networks, one or more satellite networks, one or more passive optical network (PONs), one or more packet switched telephone networks (PSTNs) and/or any other networks that permit the transfer and/or reception of data. The first data network 104 may utilize one or more protocols of network clients. The first data network 104 may also translate to or from other protocols to one or more protocols of network clients. In exemplary embodiments, the first data network 104 may include one or more of the exemplary networks recited above operating as a stand-alone network or in cooperation with each other. Use of the term network herein is not intended to limit the network to a single network.

Telephone device 112 may be in communication with and/or have access to one or more first data networks 104. For example, telephone device 112 may communicate with the VVM system 100 using the first data network 104.

Telephone device 112 may include, but is not limited to, a computer device or communications device including, e.g., a telephone, a cellular telephone, a smart telephone, a personal computer (PC), a workstation, a mobile device, a handheld PC, a personal digital assistant (PDA), a thin system, a fat system, a network appliance, an Internet browser, a server, a lap top device, and/or any other device that is configured to generate and/or transmit VVM data signals to one or more VVM servers 102. VVM data signals may include VVM data, such as data associated with one or more VVM messages.

Telephone device 112 may include software and/or hardware configured to generate one or more VVM data signals and/or transmit one or more VVM data signals to one or more VVM servers 102 via the first data network 104. In various embodiments, one or more VVM data signals may be generated based on audio input from a user using one or more telephone devices 112 associated with the user. For example, a first telephone device associated with a first user (e.g., John Doe) may generate one or more VVM data signals (e.g., one or more new VVM messages) based on audio input from the first user. In another example, a second telephone device associated with a second user (e.g., Jane Doe) may generate one or more VVM data signals based on audio input from the second user. In yet another example, a third telephone device associated with a third user (e.g., John Smith) may generate one or more VVM data signals based on audio input from the third user.

VVM server 102 may be in communication with and/or have access to one or more first data networks 104. For example, VVM server 102 may communicate with the VVM system 100 using the first data network 104.

VVM server 102 may include, but is not limited to, a computer device or communications device including, e.g., a personal computer (PC), a workstation, a thin system, a fat system, a network appliance, a server, a lap top device, and/or any other device that is configured to receive and/or store VVM data associated with one or more mobile devices, generate and/or transmit notification message signals indicating the occurrence of one or more voice mail events to one or more mobile devices 110, receive and/or analyze one or more session initiation message signals associated with one or more mobile devices 110, and/or establish one or more communication sessions between the VVM server 102 and one or more mobile devices 110.

Mobile device 110 may be in communication with and/or have access to one or more first data networks 104. For example, mobile device 110 may communicate with the VVM system 100 using the first data network 104.

Mobile device 110 may include, but is not limited to, a computer device or communications device including, e.g., a telephone, a cellular telephone, a smart telephone, a personal computer (PC), a workstation, a mobile device, a handheld PC, a personal digital assistant (PDA), a thin system, a fat system, a network appliance, an Internet browser, a server, a lap top device, and/or any other device that is configured to receive and/or process one or more notification message signals from the VVM server 102, generate and/or transmit one or more session initiation message signals to the VVM server 102, establish one or more communication sessions between the mobile device 110 and one or more VVM servers 102, and/or receive, store, and/or output VVM data associated with the mobile device 110.

FIG. 1B illustrates a block diagram of an exemplary implementation of a VVM system 100 in accordance with exemplary embodiments. In an exemplary embodiment, the VVM system 100 may include one or more VVM servers 102, one or more first data networks 104, one or more second data networks 106, one or more third data networks 108, one or more fourth data networks 114, one or more mobile devices 110, and/or one or more telephone devices 112. It is noted that the devices/networks 102, 104, 106, 108, 110, 112, and 114 are exemplary. The functions of the devices/networks 102, 104, 106, 108, 110, 112, and 114 may be performed at other devices/networks remote or local to the VVM system 100, and the devices/networks 102, 104, 106, 108, 110, 112, and 114 may be combined and/or separated.

The VVM system 100 may be in communication with the first data network 104, the second data network 106, the third data network 108, and/or the fourth data network 114. The first data network 104, the second data network 106, the third data network 108, and/or the fourth data network 114 may include one or more of a local area networks (LANs), one or more wide area networks (WANs), one or more radio access networks (RANs), the Internet, one or more cellular networks, one or more satellite networks, one or more passive optical network (PONs), one or more packet switched telephone networks (PSTNs) and/or any other networks that permit the transfer and/or reception of data. The first data network 104, the second data network 106, the third data network 108, and/or the fourth data network 114 may utilize one or more protocols of network clients. The first data network 104, the second data network 106, the third data network 108, and/or the fourth data network 114 may also translate to or from other protocols to one or more protocols of network clients. In exemplary embodiments, the first data network 104, the second data network 106, the third data network 108, and/or the fourth data network 114 may include one or more of the exemplary networks recited above operating as a stand-alone network or in cooperation with each other. Use of the term network herein is not intended to limit the network to a single network.

In an exemplary embodiment, the second data network 106 may include a packet switched telephone network (PSTN) and/or any other network configured to transmit voice mail data signals from one or more telephone devices 112 to the first data network 104 via data path 124. In an exemplary embodiment, the third data network 108 may include a wireless radio access network (RAN) and/or any other network configured to transmit one or more notification message signals received from the first data network 104 via data path 118 to one or more mobile devices 110 via data path 116 and/or transmit one or more session initiation message signals received from the one or more mobile devices 110 via data path 116 to the first data network 104 via data path 118. In an exemplary embodiment, the fourth data network 114 may include the Internet and/or any other network configured to transmit data signals and/or receive data signals associated with the VVM system 100.

Telephone device 112 may be in communication with and/or have access to one or more first data networks 104, one or more third data networks 108, and/or one or more fourth data networks 114 via second data network 106. Voice mail server 102 may be in communication with and/or have access to one or more second data networks 106, one or more third data networks 108, and/or one or more fourth data networks 114 via first data network 104. Mobile device 110 may be in communication with and/or have access to one or more first data networks 104, one or more second data networks 106, and/or one or more fourth data networks 114 via third data network 108.

In an exemplary embodiment, one or more data paths disclosed herein may include any device that communicatively couples one or more devices to each other. For example, data path 116, data path 118, data path 120, data path 122, data path 124, and/or data path 126 may include one or more networks, etc. The mobile device 110 and the VVM server 102 are discussed in further detail below.

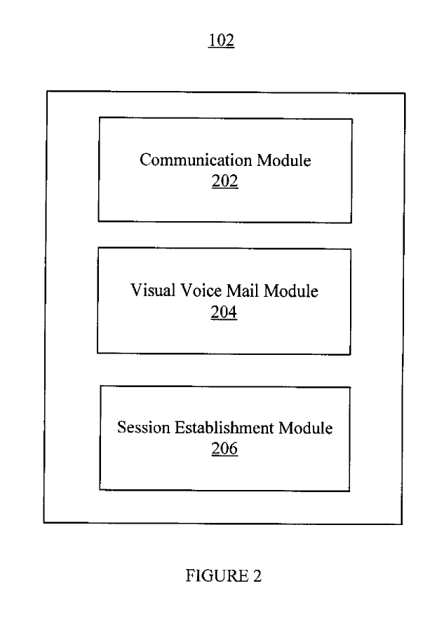

FIG. 2 illustrates exemplary modules of a VVM server 102 of a VVM system 100 in accordance with exemplary embodiments. In an exemplary embodiment, the VVM server 102 may include a communication module 202, a VVM module 204, and a session establishment module 206. It is noted that the modules 202, 204, and 206 are exemplary. The functions of the modules 202, 204, and 206 may be performed by other modules remote or local to the voice mail server 102, and the modules 202, 204, and 206 may be combined and/or separated.

The communication module 202 may include software and/or hardware configured to provide communication between the VVM server 102 and the first data network 104 via data path 120. In various embodiments, the communication module 202 may be configured to receive and/or transmit data signals from/to one or more devices/networks associated with the VVM system 100. In various embodiments, the communication module 202 may be configured to transmit the data signals and/or messages received from the first data network 104 via data path 120 to the other modules 204 and 206, and may communicate data signals and/or messages received from the other modules 204 and 206 to the first data network 104 via data path 120.

The VVM module 204 may include software and/or hardware configured to establish and/or store one or more voice mail accounts associated with one or more mobile devices 110. In various embodiments, each voice mail account, the associated mobile device 110, and/or the associated VVM data may be identified using a voice mail account unique identification number (UID). For example, a first voice mail account of a first mobile device 110 may be associated with a first voice mail account unique identification number (e.g., “123456”). In another example, a second voice mail account of a second mobile device 110 may be associated with a second voice mail account unique identification number (e.g., “987654”). In yet another example, a third voice mail account of a third mobile device 110 may be associated with a third voice mail account unique identification number (e.g., “111222”). In various embodiments, the voice mail account unique identification number (UID) may include a telephone number of the mobile device 110.

The VVM module 204 may include software and/or hardware configured to receive one or more VVM data signals (e.g., VVM data) from one or more telephone devices 112. In various embodiments, receiving one or more VVM data signals may include receiving one or more new VVM messages associated with one or more voice mail accounts.

The VVM module 204 may include software and/or hardware configured to store the received VVM data signals according to the voice mail account to which the VVM data signals are directed. In various embodiments, storing the VVM data signals according to the associated voice mail account may include accessing the voice mail account unique identification number (UID) associated with the VVM data signals.

The VVM module 204 may include software and/or hardware configured to monitor one or more voice mail accounts to determine whether one or more voice mail events have occurred. In various embodiments, the VVM module 204 may be configured to determine that a voice mail event has occurred if a voice mail account has received new VVM data and/or one or more voice mail settings associated with the voice mail account have been modified (e.g., a PIN change, status change of voice mail due to retrieval). For example, the VVM module 204 may determine that a first voice mail event has occurred within a voice mail account based on the receipt of a new VVM message. In another example, the VVM module 204 may determine that a second voice mail event has occurred within the voice mail account based on the modification of a Personal Identification Number (PIN) associated with voice mail account. In yet another example, the VVM module 204 may determine that a third voice mail event has occurred with the voice mail account based on change in status of the VVM messages that is due to the retrieval of a new VVM message. In various embodiments, the VVM module 204 may be configured to monitor one or more event notification triggers associated with one or session protocols (e.g., the event notifications for message waiting indication (MWI) associated with the Session Initiation Protocol SIP) to determine whether one or more voice mail events have occurred.

If, for example, the VVM module 204 determines that a voice mail event has not occurred, the VVM module 204 may continue to monitor the one or more voice mail accounts. If, however, the VVM module 204 determines that a voice mail event has occurred, the VVM server 102 may generate and/or transmit one or more notification messages to the mobile device 110 associated with the voice mail event using the communication module 202. In various embodiments, the VVM server 102 may generate and/or transmit a notification message that includes a VVM message unique identification number (UID) associated with a new VVM message.

The session establishment module 206 may include software and/or hardware configured to receive one or more session initiation messages from one or more mobile devices 110. For example, in response to the transmission of a notification message to a mobile device 110 associated with a voice mail event, the session establishment module 206 may be configured to receive one or more session initiation messages from the mobile device 110. A session initiation message may include data associated with the attempt of a mobile device 110 to initiate a communication session between the mobile device 110 and the VVM server 102.

The session establishment module 206 may include software and/or hardware configured to establish one or more communication sessions between the VVM server 102 and one or more mobile devices 110. A communication session may include a time span in which one or more devices are communicatively coupled to each other for the purpose of receiving, retrieving, exchanging, and/or providing data. For example, in response to receiving one or more session initiation messages from a first mobile device (e.g., a smart phone belonging to John Doe), the session establishment module 206 may establish a first communication session between the first mobile device and the VVM server 102. In another example, in response to receiving one or more session initiation messages from a second mobile device (e.g., a cellular phone belonging to Jane Doe), the session establishment module 206 may establish a second communication session between the second mobile device and the VVM server 102. In yet another example, in response to receiving one or more session initiation messages from a third mobile device (e.g., a telephone configured to operate using Voice over Internet Protocol (VoIP) that belongs to John Smith), the session establishment module 206 may establish a third communication session between the third mobile device and the VVM server 102. In various embodiments, the session establishment module 206 may be configured to use one or more devices, one or more software applications, one or more methods, and/or one or more systems known in the art for establishing communication sessions between one or more devices at a server end of a system.

In various embodiments, the VVM server 102 may be configured to allow one or more mobile devices 110 to retrieve VVM data from the VVM server 102 via one or more communication sessions. In various embodiments, the VVM server 102 may be configured to transmit VVM data to one or more mobile devices 110 via one or more communication sessions.

The session establishment module 206 may include software and/or hardware configured to terminate one or more communication sessions after one or more mobile devices 110 have successfully retrieved and/or received VVM data. It should be noted that the amount of time that elapses prior to the termination of a communication session may be determined by the implementers of the VVM system 100 based on design preferences.

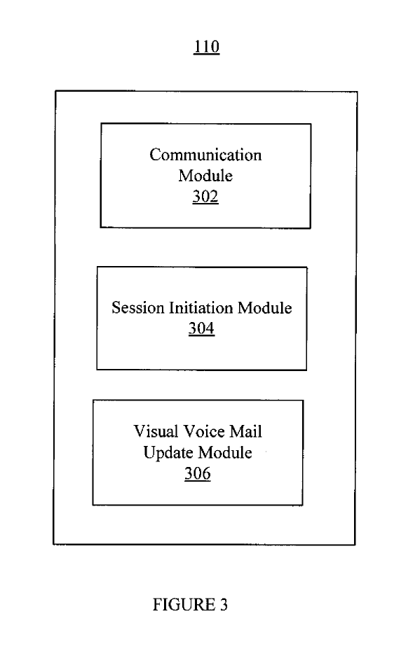

FIG. 3 illustrates exemplary modules of a mobile device 110 of a VVM system 100 in accordance with exemplary embodiments. In an exemplary embodiment, the mobile device 110 may include a communication module 302, a session initiation module 304, and a VVM update module 306. It is noted that the modules 302, 304, and 306 are exemplary. The functions of the modules 302, 304, and 306 may be performed by other modules remote or local to the mobile device 110, and the modules 302, 304, and 306 may be combined and/or separated.

The communication module 302 may include software and/or hardware configured to provide communication between the mobile device 110 and the third data network 108 via data path 116. In various embodiments, the communication module 302 may be configured to receive and/or transmit data signals from/to one or more devices/networks associated with the VVM system 100. In various embodiments, the communication module 302 may be configured to transmit the data signals and/or messages received from the third data network 108 via data path 116 to the other modules 304 and 306, and may communicate data signals and/or messages received from the other modules 304 and 306 to the third data network 108 via data path 116. In various embodiments, the communication module 302 may include software and/or hardware configured to receive one or more notification messages from one or more VVM servers 102.

The session initiation module 304 may include software and/or hardware configured to generate and/or transmit one or more session initiation messages to the VVM server 102. In various embodiments, the session initiation module 304 may be configured to generate and/or transmit one or more session initiation messages to the VVM server 102 in response to receiving one or more notification messages from the VVM server 102.

The session initiation module 304 may include software and/or hardware configured to establish one or more communication sessions between the mobile device 110 and one or more VVM servers 102. In various embodiments, the session initiation module 304 may be configured to use one or more devices, one or more software applications, one or more methods, and/or one or more systems known in the art for establishing communication sessions between one or more devices.

The VVM update module 306 may include software and/or hardware configured to store VVM data and/or retrieve VVM data from a VVM server 102. In various embodiments, the VVM update module 306 may be configured to retrieve VVM data from one or more VVM servers 102 via one or more communication sessions. In various embodiments, the VVM update module 306 may be configured to retrieve VVM data from a VVM server 102 according to one or more data retrieval protocols IMAP.

The VVM update module 306 may include software and/or hardware configured to update the previously stored VVM data with the VVM data retrieved from the VVM server 102. In various embodiments, updating VVM data may include the VVM update module 306 synchronizing the VVM data associated with the mobile device 110 with the VVM data associated with the VVM server 102 such that a user of the mobile device 110 maintains access to the latest VVM data (e.g., new VVM messages, changes in voice mail settings).

The VVM update module 306 and/or the mobile device 110 may include software and/or hardware configured to output (e.g., display, allow access to) the VVM data to the user of the mobile device 110. For example, the VVM update module 306 and/or the mobile device 110 may be configured to output the VVM data using one or more visual VVM capabilities of the mobile device 110. Accordingly, the mobile device 110 may enable the user to manipulate the VVM data in accordance with VVM technologies (e.g., sort, play out of order).

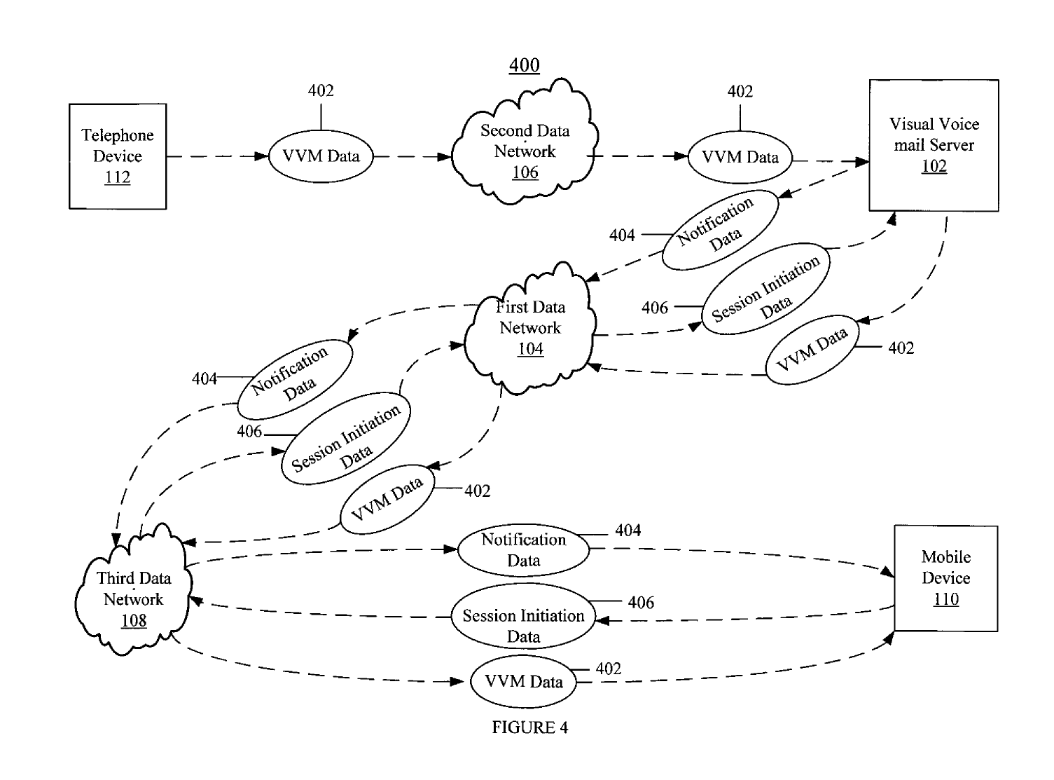

FIG. 4 illustrates an exemplary schematic of an implementation of a VVM system 100 that has been optimized by reducing the use of bandwidth resources in accordance with exemplary embodiments. It should be noted that this illustration is based on the exemplary implementation of a VVM system 100 illustrated in FIG. 1B. As previously described, the VVM system 100 may decrease the amount of bandwidth required to maintain synchronization between the VVM data associated with a VVM server 102 and the VVM data associated with a mobile device 110. Accordingly, the VVM system 100 may initiate, establish, and/or maintain temporary communication sessions (e.g., short lived communication sessions) between the VVM server 102 and the mobile device 110 to enable VVM data retrieval. By way of a non-limiting example, the VVM system 100 may operate as illustrated in FIG. 4.

In various embodiments, a telephone device 112 may generate VVM data 402 and/or deposit VVM data 402 associated with a mobile device 110 into the VVM server 102 via the second data network 106. Based on the receipt of the new VVM data 402 (e.g., a new VVM message), the VVM server 102 may determine that a voice mail event associated with the mobile device 110 has occurred. In response to the voice mail event, the VVM server 102 may generate notification data 404 (e.g., a notification message that indicates the existence of the VVM data 402) and/or transmit the notification data 404 to the mobile device 110 via the first data network 104 and/or the third data network 108.

In various embodiments, the mobile device 110 may receive the notification data 404. In response to the receipt of the notification data 404, the mobile device 110 may generate session initiation data 406 (e.g., a session initiation message) and/or transmit the session initiation data to the VVM server 102 via the third data network 108 and/or the first data network 104. In various embodiments, the VVM server 102 and/or the mobile device 110 may establish a communication session based on the session initiation data 406. The mobile device 110 may then retrieve the VVM data 402 from the VVM server 102 using one or more voice mail account UIDs and/or one or more VVM message UIDs. Subsequent to the retrieval of the VVM data 402, the communication session between the VVM server 102 and the mobile device 110 may be terminated. It should be noted that if the voice mail event is associated with a change in voice mail settings, the mobile device may not use a VVM message UID.

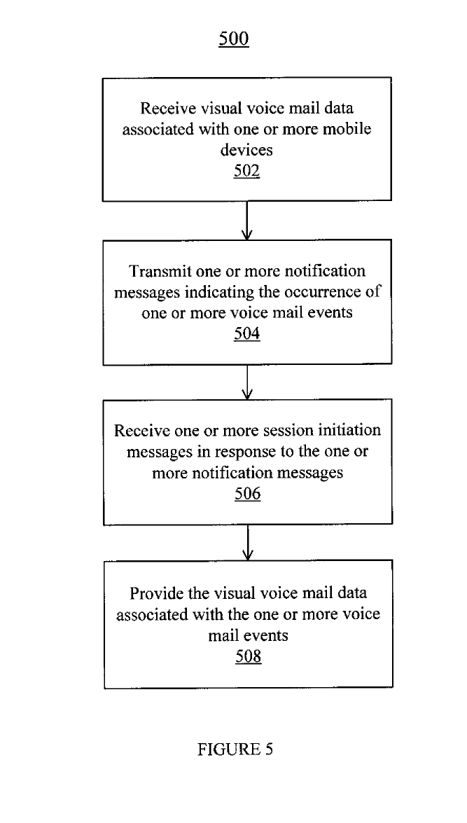

FIG. 5 illustrates a flowchart of a method 500 for optimizing a VVM system 100 by reducing the use of bandwidth resources at a VVM server 102 in accordance with exemplary embodiments. This exemplary method is provided by way of example, as there are a variety of ways to carry out methods disclosed herein. The method 500 shown in FIG. 5 can be executed or otherwise performed by one or a combination of various systems. The method 500 is described below as carried out by the VVM server 102 of the VVM system 100 shown in FIG. 1 by way of example, and various elements of the VVM server 102 are referenced in explaining the example method 500 of FIG. 5. Each block shown in FIG. 5 represents one or more processes, methods, or subroutines carried out in the exemplary method 500. Referring to FIG. 5, the exemplary method 500 may begin at block 502.

In block 502, VVM data associated with one or more mobile devices may be received. In an exemplary embodiment, a VVM module 204 of a VVM server 102 may receive VVM data from one or more telephone devices 112. In various embodiments, the VVM module 204 may receive VVM data via the first data network 104. The method 500 may continue to block 504.

In block 504, one or more notification messages indicating an occurrence of one or more voice mail events may be transmitted. In an exemplary embodiment, the communication module 202 of the VVM server 102 may transmit one or more notification messages indicating an occurrence of one or more voice mail events to the one or more mobile devices 110. The method 500 may continue to block 506.

In block 506, one or more session initiation messages may be received in response to the one or more notification messages. In an exemplary embodiment, the session establishment module 206 of the VVM server 102 may receive one or more session initiation messages from one or more mobile devices 110 in response to the one or more notification messages. The method 500 may continue to block 508.

In block 508, the VVM data associated with the one or more voice mail events may be provided. In an exemplary embodiment, the VVM module 204 of the VVM server 102 may provide the VVM data associated with one or more voice mail events to the one or more mobile devices 110 via one or more communication sessions. The method 500 may then end.

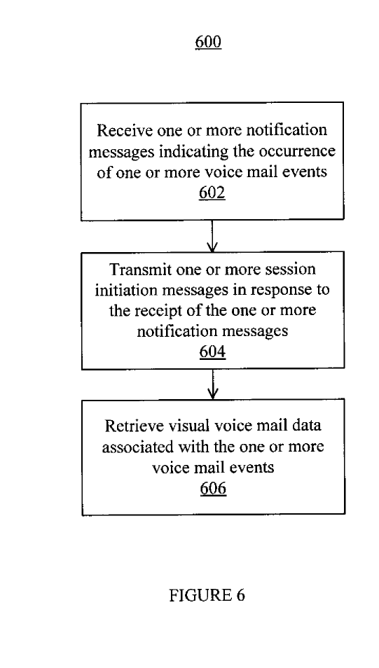

FIG. 6 illustrates a flowchart of a method 600 for optimizing a VVM system 100 by reducing the use of bandwidth resources at a mobile device 110 in accordance with exemplary embodiments. This exemplary method is provided by way of example, as there are a variety of ways to carry out methods disclosed herein. The method 600 shown in FIG. 6 can be executed or otherwise performed by one or a combination of various systems. The method 600 is described below as carried out by the mobile device 110 of the VVM system 100 shown in FIG. 1 by way of example, and various elements of the mobile device 110 are referenced in explaining the example method 600 of FIG. 6. Each block shown in FIG. 6 represents one or more processes, methods, or subroutines carried out in the exemplary method 600. Referring to FIG. 6, the exemplary method 600 may begin at block 602.

In block 602, one or more notification messages indicating the occurrence of one or more voice mail events may be received. In an exemplary embodiment, a communication module 302 of the mobile device 110 may receive one or more notification messages indicating the occurrence of one or more voice mail events from the VVM server 102 via the first data network 104. The method 600 may continue to block 604.

In block 604, one or more session initiation messages may be transmitted in response to the receipt of the one or more notification messages. In an exemplary embodiment, a session initiation module 304 of the mobile device 110 may transmit one or more session initiation messages to the VVM server 102 in response to the receipt of the one or more notification messages. In various embodiments, the session initiation messages may be transmitted to the VVM server 102 via the first data network 104. The method 600 may continue to block 606.

In block 606, VVM data associated with the one or more voice mail events may be retrieved. In an exemplary embodiment, the VVM update module 306 of the mobile device 110 may retrieve the VVM data associated with the one or more voice mail events from the VVM server 102 via one or more communication sessions between the mobile device 110 and the VVM server 102. The method 600 may then end.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving, from a server, one or more notification messages indicating an occurrence of one or more voice mail events via a network;
transmitting, to the server, one or more session initiation messages in response to the receipt of the one or more notification messages via the network; and
retrieving, from the server, voice mail data associated with the one or more voice mail events via a communication session.

2. The method of claim 1, wherein the one or more notification messages comprise one or more Session Initiation Protocol (SIP) notification messages.

3. The method of claim 1, wherein the one or more voice mail events comprise at least one of an existence of one or more new voice mail messages and a modification of one or more voice mail settings.

4. The method of claim 1, wherein the network comprises a wireless Radio Access Network (RAN).

5. The method of claim 1, further comprising establishing the communication session with the server as a result of the transmission of the one or more session initiation messages.

6. The method of claim 1, further comprising synchronizing data associated with a voice mail display with the voice mail data retrieved from the server.

7. The method of claim 1, wherein the server comprises at least one of a voice mail server and a Internet Message Access Protocol (IMAP) server.

8. A computer readable media comprising code to perform the acts of the method of claim 1.

9. A system, comprising:
a communication module configured to receive, from a server, one or more notification messages indicating an occurrence of one or more voice mail events via a network;
a session initiation module configured to transmit, to the server, one or more session initiation messages in response to the receipt of the one or more notification messages via the network; and
a voice mail update module configured to retrieve, from the server, voice mail data associated with the one or more voice mail events via a communication session.

10. The system of claim 9, wherein the one or more notification messages comprise one or more Session Initiation Protocol (SIP) notification messages.

11. The system of claim 9, wherein the one or more voice mail events comprise at least one of an existence of one or more new voice mail messages and a modification of one or more voice mail settings.

12. The system of claim 9, wherein the network comprises a wireless Radio Access Network (RAN).

13. The system of claim 9, wherein the session initiation module is further configured to establish a communication session with the server as a result of the transmission of the one or more session initiation messages.

14. The system of claim 9, wherein the voice mail update module is further configured to synchronize data associated with a voice mail display with the voice mail data retrieved from the server.

15. The system of claim 9, wherein the server comprises at least one of a voice mail server and a Internet Message Access Protocol (IMAP) server.

16. A method, comprising:
receiving, from one or more telephone devices, voice mail data associated with one or more mobile devices via one or more networks;
transmitting, to the one or more mobile devices, one or more notification messages indicating an occurrence of one or more voice mail events;
receiving, from the one or more mobile devices, one or more session initiation messages in response to the one or more notification messages; and
providing, to the one or more mobile devices, the voice mail data associated with the one or more voice mail events.

17. The method of claim 16, wherein the one or more notification messages comprise one or more Session Initiation Protocol (SIP) notification messages.

18. The method of claim 16, wherein the one or more voice mail events comprise at least one of an existence of one or more new voice mail messages and a modification of one or more voice mail settings.

19. The method of claim 16, wherein the one or more networks comprise at least one of a wireless Radio Access Network (RAN), a Wide Area Network (WAN), a Packet Switched Telephone Network (PSTN), and a Local Area Network (LAN).

20. The method of claim 16, further comprising establishing a communication session with the one or more mobile devices in response to the receipt of the one or more session initiation messages.

21. The method of claim 16, wherein the one or more mobile devices comprise one or more Internet Message Access Protocol (IMAP) clients.

22. A computer readable media comprising code to perform the acts of the method of claim 16.

23. A system, comprising:
a voice mail module configured to receive, from one or more telephone devices, voice mail data associated with one or more mobile devices via one or more networks;
a communication module configured to transmit, to the one or more mobile devices, one or more notification messages indicating an occurrence of one or more voice mail events;
a session establishment module configured to receive, from the one or more mobile devices, one or more session initiation messages in response to the one or more notification messages; and
the voice mail module configured to provide, to the one or more mobile devices, the voice mail data associated with the one or more voice mail events.

24. The system of claim 23, wherein the one or more notification messages comprise one or more Session Initiation Protocol (SIP) notification messages.

25. The system of claim 23, wherein the one or more voice mail events comprise at least one of an existence of one or more new voice mail messages and a modification of one or more voice mail settings.

26. The system of claim 23, wherein the one or more networks comprise at least one of a wireless Radio Access Network (RAN), a Wide Area Network (WAN), a Packet Switched Telephone Network (PSTN), and a Local Area Network (LAN).

27. The system of claim 23, wherein the session establishment module is further configured to establish a communication session with the one or more mobile devices in response to the receipt of the one or more session initiation messages.

28. The system of claim 23, wherein the one or more mobile devices comprise one or more Internet Message Access Protocol (IMAP) clients.
